(19) United States
(12) Patent Application Publication
(10) Pub. No.: US 2005/0050999 A1
(43) Pub. Date: Mar. 10, 2005

(54) Retention stand for a workpiece such as a jar

(76) Inventor: Colin Michael Kernan, Hingham, MA (US)

Correspondence Address: STEVEN A. GARNER;CONAIR CORPORATION, ONE CUMMINGS POINT ROAD, STAMFORD, CT, 06902, US

(21) Appl. No.: 10/938,192

(22) Filed: Sep. 10, 2004

Related U.S. Application Data
(60) Provisional application No. 60/502,029, filed on Sep. 10, 2003.

(51) Int. Cl. B67B 7/46

(52) U.S. Cl. 81/3.32

(57) ABSTRACT

A small, portable retention stand for clamping and retaining a cylindrical object while forces, including torque, are applied to the object is particularly adapted to hold a cylindrical jar. The stand has a base that stands on a flat surface and that is connected to a housing. Within the housing are components that make up a ratchet-type sliding track that cooperates with a sliding planar member that slides in and out of the housing in a drawer-like fashion. The sliding member has a raised contact surface of, preferably, a concave arc adapted to engage the outer surface of a jar. An opposing concave surface is on the wall of the housing facing the raised contact surface. Both surfaces may be provided with resilient gripping materials such as rubber to engage the outside circumference of a jar. In use, the sliding member is withdrawn from the housing to an extent to allow ajar to be positioned on the sliding member. The sliding member is then slid into the housing, in ratcheting fashion, to clinch the jar between the raised contact surface and the wall of the housing, between the corresponding gripping surfaces. The jar is held sufficiently tightly to enable torque to be applied to the jar lid by hand or by mechanical or automatic means in order to loosen the jar.

### CROSS-REFERENCE TO RELATED APPLICATIONS

This application claims priority to U.S. Provisional Patent Application Ser. No. 60/502,029 filed on Sep. 10, 2003, incorporated herein by reference in its entirety.

### BACKGROUND OF THE INVENTION

1. Field of the Invention

The present invention relates to a retention stand for a workpiece to which torque is to be applied including, but not limited to, jars with twist lids.

2. Description of Related Art

Clamps and vises of various types are known in the art and are used for holding an object or workpiece stationary in a manner in which it will maintain its position when one or more types of force (e.g., linear, torque) are applied to the workpiece. Known clamps of this type are usually provided with steel or iron contact surfaces for clamping the workpiece, and they are anchored to a bench or weighted to resist movement when external forces are applied. Other known clamping devices exist for light duty in which rubberized pads are provided as contact surface, but such clamping devices are not weighted or anchored and are typically handheld clamps. In addition, the contact pads in such devices are usually planar and are limited to gripping objects that have planar surfaces.

There exists a need for a clamping device that grips cylindrical objects and resists torque such that external torque can be applied to an object held in the clamping device.

### OBJECT AND SUMMARY OF THE INVENTION

It is an object of the present invention to provide a clamping device for retaining a cylindrical object in a manner that external torque force can be applied to the object while it is maintained stationary. It is a further object that the device be efficient, light, portable, small, and reliable. These and other objects are achieved by the present invention described herein.

The present invention is directed to a small, portable, retention stand for clamping and retaining a cylindrical object while forces, including torque, are applied to the object. In the preferred embodiment, the retention stand according to the present invention is directed to a stand particularly adapted to hold a cylindrical jar, though it is not necessarily limited thereto. The stand has a base that stands on a flat surface and that is connected to a housing. Within the housing are components that make up a ratchet type sliding track that cooperates with a sliding planar member that slides in and out of the housing in a drawer-like fashion. The sliding member has a raised contact surface of, preferably, a concave arc adapted to engage the outer surface of ajar. An opposing concave surface is on the wall of the housing facing the raised contact surface. Both surfaces may be provided with resilient gripping materials such as rubber to engage the outside circumference of a jar. In use, the sliding member is withdrawn from the housing to an extent to allow a jar to be positioned on the sliding member. The sliding member is then slid into the housing, in ratcheting fashion, to clinch the jar between the raised contact surface and the wall of the housing, between the corresponding gripping surfaces. The jar is held sufficiently tightly to enable torque to be applied to the jar lid by hand or by mechanical or automatic means in order to loosen the jar.

### BRIEF DESCRIPTION OF THE DRAWINGS

FIG. 1 is a perspective illustration of a device according to the preferred embodiment of the present invention shown in an opened position.

FIG. 2 is a perspective illustration of a device according to the preferred embodiment of the present invention shown in a closed position.

FIG. 3 is a bottom, cut-away view of the device according to the preferred embodiment of the present invention shown in the opened position.

FIG. 4A is a bottom, cut-away view of the device according to the preferred embodiment of the present invention shown in the closed position.

FIG. 4B is an enlargement of the highlighted portion of FIG. 4A.

FIGS. 5A and 5B are further enlarged views of FIGS. 4A and 4B, respectively.

FIGS. 6A-6F are exterior views of the device according to the preferred embodiment of the present invention shown in top (closed), front, rear, first side, second side, and top (opened) views, respectively.

FIGS. 7A and 7B are, respectively, top closed and side cross-sectional views of the device according to the preferred embodiment.

### DESCRIPTION OF THE PREFERRED EMBODIMENT

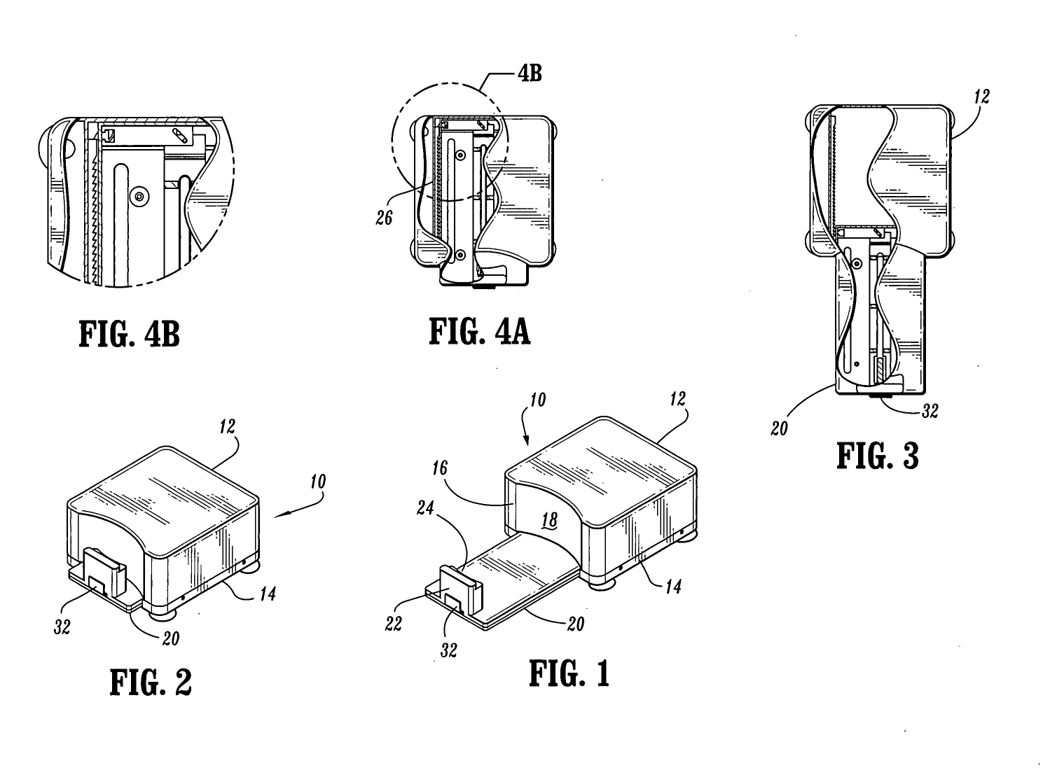

Referring to the exterior views of FIGS. 1 and 2, there is shown a retention device (10) according to the preferred embodiment of the present invention that comprises an exterior housing (12) attached to a base (14). The base (14) is adapted to rest on a generally flat surface such as a tabletop. As shown in FIGS. 1-3, suction cups can be used to secure the base to the generally flat surface. In alternate embodiments, bolts, brackets, or any other means known to one skilled in the art, can be employed. The housing (12) has four exterior walls including a front wall (16) which may be provided with an arcuately concave portion (18). A sliding planar member (20) is adapted to slide into and out of the housing (12) between the positions shown in FIGS. 1-2, referred to, respectively, as the “opened” and “closed” positions. The sliding member (20) has an upwardly extending contact portion (22) having on its side facing the front wall (16) an arcuately concave gripping surface (24). Each of the arcuately concave portions (18) of the front wall (16) and the gripping surface (22) may be provided with resilient, gripping material such as rubber in order to enhance gripping. While the shape of these gripping surfaces is concave, it is conceivable to substitute for the concave shape a multi-plane section such as those shown in FIGS. 8A and 8B, each of which will engage a circumferential surface of a jar between the planar sections.

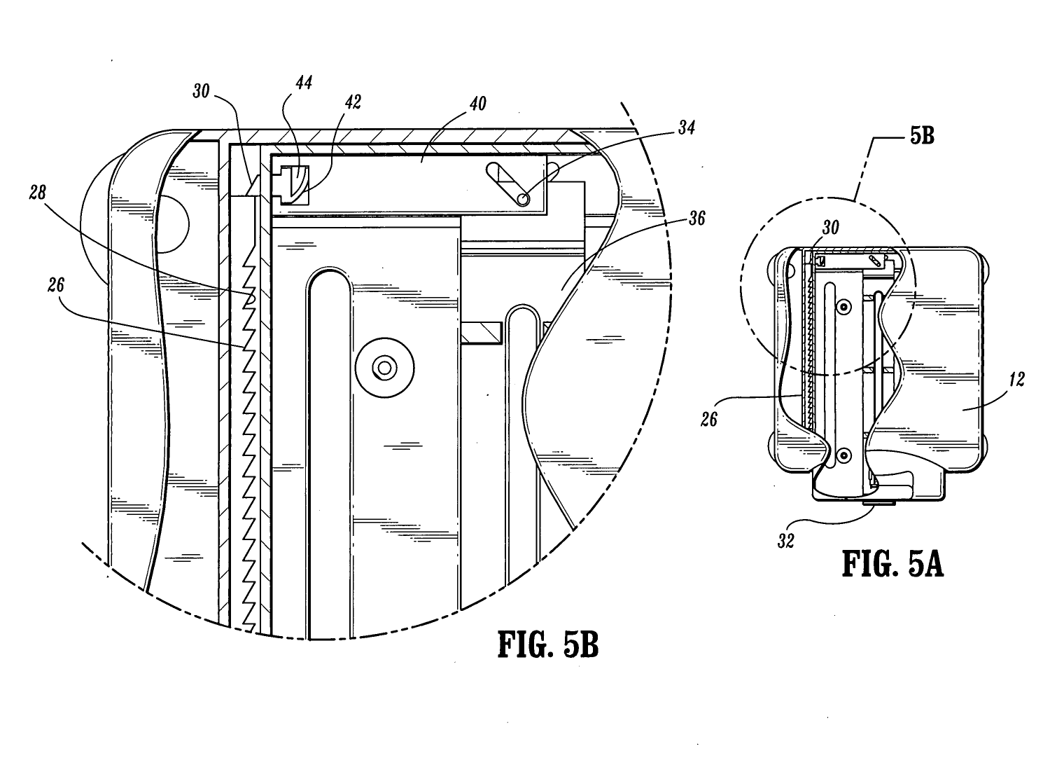

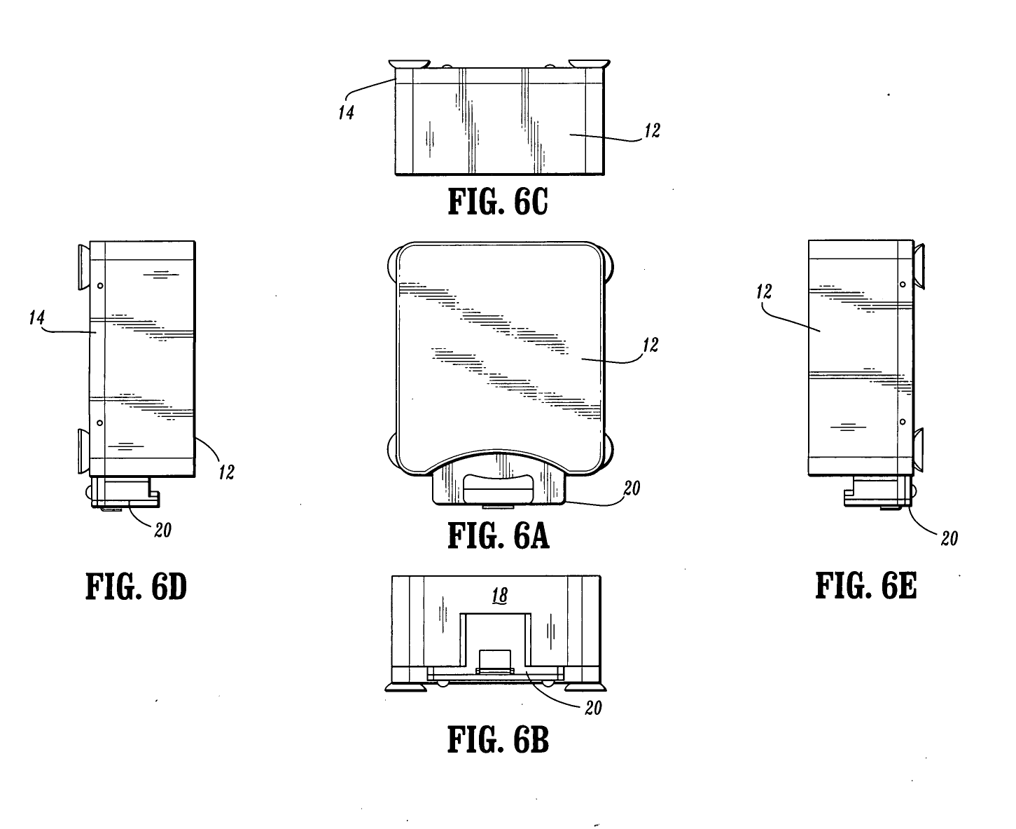

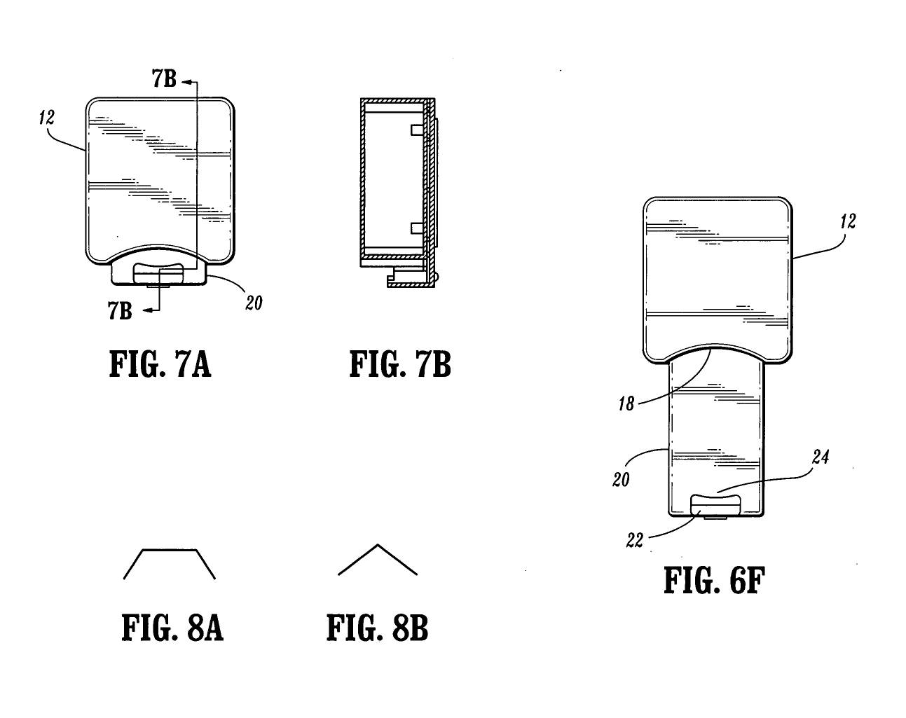

Referring now to FIGS. 4A, 4B, 5A and 5B, there is shown a ratchet track (26) housed in the housing (12) having teeth (28) adapted to engage a pawl (30) that is fixed to the underside of the sliding member (20). The pawl (30) moves with the sliding member (20) when it is slid into or out of the housing (12) such that the pawl (30) engages the teeth (28). When the pawl (30) is stopped in a position where it engages the teeth (28) of the rack (26), the sliding member (20) is locked against moving outwardly from the housing (12). This clamps ajar into the device (10). To release the jar, a button (32) is pushed which causes the pawl (30) to be moved away from the rack (26) due to cooperation between a pin (34) fixed to a rigid member (36) that is moved by activation of the button (32) and a slot (38). The movement of the rigid member (36) relative to the slot (38) causes the linkage (40) bearing the slot (38) to move away from the rack (26) as the linkage (40) moves. A spring member (42) is provided to allow the pawl (30) to move within a space (44) in the linkage (40) when the pawl (30) is ratcheted or moved over the teeth (28) during sliding in. During sliding out of the housing, the linkage (40) and pawl (30) are moved away from the rack (26) and no ratcheting occurs. The specific components that make up the ratcheting system may be arranged in other ways known to those skilled in the art to achieve the same effect.

While a preferred embodiment of the invention has been herein disclosed and described, it is understood that various modifications can be made without departing from the scope of the invention.

1. A retention stand comprising:
a housing;
a first contact surface adapted to contact an object to be retained by said stand; and
a second contact surface movable relative to said first contact surface adapted to contact said object.

2. A retention stand according to claim 1, wherein
said first and second surfaces are generally parallel.

3. A retention stand according to claim 1, wherein
said first and second surfaces are aligned generally vertically.

4. A retention stand according to claim 1, further comprising
a generally horizontal support surface for supporting said object while it is in contact with at least one of said first and second surfaces.

5. A retention stand according to claim 4, wherein
said second contact surface is supported at a first end of said horizontal support surface.

6. A retention stand according to claim 5, further comprising
a slot in said housing.

7. A retention stand according to claim 6, further comprising
a ratchet track within said housing adapted to prevent said first member from sliding out of said housing, said ratchet track comprising
a plurality of teeth within said housing; and
a pawl fixed to said first member and adapted to engage said plurality of teeth to lock said first member from moving out of said housing.

8. A retention stand according to claim 7, further comprising
a release system adapted to selectively release said pawl from said teeth, allowing said first member to slide out of said housing.

9. A retention stand according to claim 1, further comprising
a resilient gripping material on said first contact surface and said second contact surface.

10. A retention stand according to claim 1, wherein
said first contact surface and said second contact surface have arcuately concave shapes.

11. A retention stand according to claim 1, wherein
said first contact surface and said second contact surface have multi-plane shapes.

12. A retention stand according to claim 1, wherein
said housing further comprises a base adapted to rest on a generally flat surface.

13. A retention stand according to claim 12, further comprising
means for securing said base to said generally flat surface.

14. A retention stand according to claim 13, wherein
said means comprises suction cups.
